(19) United States
(12) Patent Application Publication
(10) Pub. No.: US 2019/0362176 A1
(43) Pub. Date: Nov. 28, 2019

(54) IMAGE PROCESSING DEVICE AND IMAGE PROCESSING METHOD

(71) Applicant: KYOCERA Document Solutions Inc., Osaka (JP)

(72) Inventor: Atsushi FUJIKI, Osaka-shi (JP)

(73) Assignee: KYOCERA Document Solutions Inc., Osaka (JP)

(21) Appl. No.: 16/420,801

(22) Filed: May 23, 2019

(30) Foreign Application Priority Data
May 28, 2018 (JP) 2018-101544

(51) Int. Cl. G06K 9/32; G06K 9/00

(52) U.S. Cl. CPC G06K 9/3233; G06K 9/00463

(57) ABSTRACT

An image processing device is for performing image processing on image data. The image processing device includes a first determining section and a second determining section. The image data indicates an editing target image including a character string image including at least one character image and at least one marking image. The first determining section determines an area pattern from among a predefined plurality of area patterns. The second determining section determines, as an editing area on which the image processing is to be performed, an area of at least a portion of the character string image based on the marking image and the determined area pattern.

### INCORPORATION BY REFERENCE

The present application claims priority under 35 U.S.C. § 119 to Japanese Patent Application No. 2018-101544, filed on May 28, 2018. The contents of this application are incorporated herein by reference in their entirety.

### BACKGROUND

The present disclosure relates to an image processing device and an image processing method.

A technique has been studied by which a character area of a document is marked and image processing such as optical character recognition (OCR) processing is performed on the area (marker area) determined by the marking. A technique has also been studied by which a circumscribed rectangular area is used as an area (editing area) on which image processing is to be performed based on a marker area.

### SUMMARY

An image processing device according to an aspect of the present disclosure is for performing image processing on image data. The image processing device includes a first determining section and a second determining section. The image data indicates an editing target image including a character string image including at least one character image and at least one marking image. The first determining section determines an area pattern from among a plurality of area patterns. The second determining section determines, as an editing area on which the image processing is to be performed, an area of at least a portion of the character string image based on the marking image and the determined area pattern.

An image processing method according to an aspect of the present disclosure is an image processing method by which image processing is performed on image data. The image data indicates an editing target image including a character string image including at least one character image and at least one marking image. The image processing method includes: determining an area pattern from among a plurality of area patterns; and determining, as an editing area on which the image processing is to be performed, an area of at least a portion of the character string image based on the marking image and the determined area pattern.

### BRIEF DESCRIPTION OF THE DRAWINGS

FIG. 1 is a schematic illustration of an example of an image processing device according to embodiments of the present disclosure.

FIG. 2 is a block diagram illustrating an example of a controller.

FIG. 3 schematically illustrates a first example of a correspondence relationship between a manner of marking and a plurality of area patterns.

FIG. 4 schematically illustrates a second example of the correspondence relationship between the manner of marking and a plurality of area patterns.

FIG. 5 schematically illustrates a third example of the correspondence relationship between the manner of marking and a plurality of area patterns.

FIG. 6 is a diagram illustrating an example of an area pattern setting screen according to a first embodiment.

FIG. 7 is a diagram illustrating an example of an editing area determination screen according to the first embodiment.

FIG. 8 is a flowchart depicting an editing area determination process according to the first embodiment.

FIG. 9 is a diagram illustrating an example of an editing area determination screen according to a second embodiment.

FIG. 10 is a flowchart depicting an editing area determination process according to the second embodiment.

### DETAILED DESCRIPTION

The following describes embodiments of the present disclosure with reference to the accompanying drawings. Elements that are the same or equivalent are labelled with the same reference signs in the drawings and description thereof is not repeated.

### First Embodiment

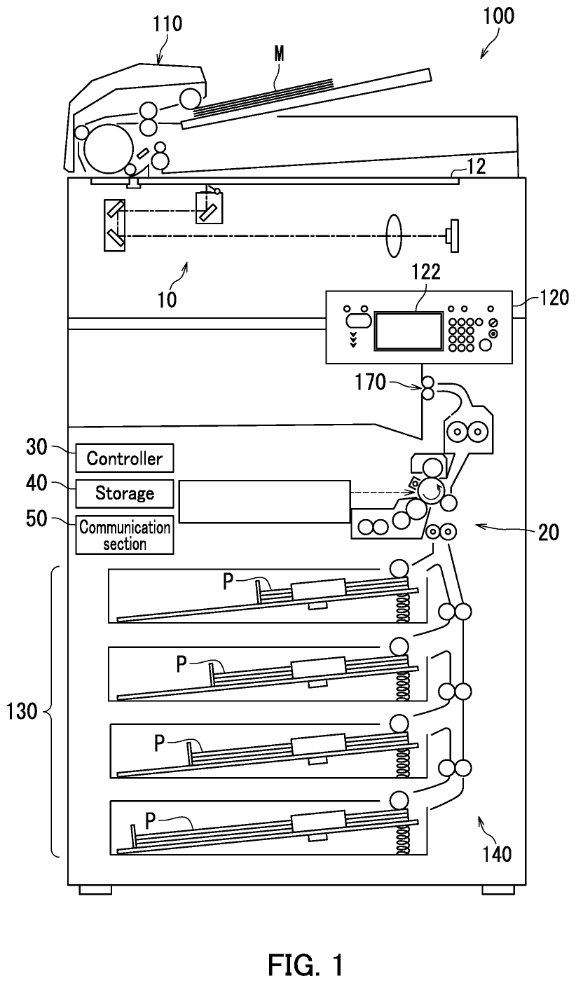

The following describes an image processing device 100 according to a first embodiment of the present disclosure with reference to FIG. 1. FIG. 1 is a schematic illustration of the image processing device 100 according to the first embodiment of the present disclosure. The image processing device 100 is a copier, a printer, a multifunction peripheral, a smartphone, or a tablet terminal, for example. In the following, a color multifunction peripheral with a printer function and a scanner function is described as an example of the image processing device 100. The present disclosure may also be applied to any devices which process marked read data or marked electronic data. Electronic marking made on a tablet is also within an applicable scope.

As illustrated in FIG. 1, the image processing device 100 includes an image reading section 10, an image forming section 20, a controller 30, storage 40, a communication section 50, a document table 12, a document conveyor device 110, an operation panel 120, a paper feed cassette 130, a paper conveyance section 140, and a paper ejecting section 170.

The image reading section 10 reads an image from a document M and acquires an image to be edited (referred to in the following as an “editing target image”). In detail, the image reading section 10 reads an image from the document M conveyed by the document conveyor device 110 or loaded on the document table 12, and acquires a color or monochrome editing target image.

The image forming section 20 forms an image on a recording medium P based on the editing target image read by the image reading section 10. The recording medium P is paper, for example.

The controller 30 is a hardware circuit including for example an application-specific integrated circuit (ASIC) and a processor such as a central processing unit (CPU). The controller 30 determines an editing area which is an area in the editing target image on which image processing is to be performed. The controller 30 controls operation of each section of the image processing device 100 through the processor reading out and executing a control program stored in the storage 40.

The controller 30 has an optical character recognition (OCR) function. The OCR function is a function which optically recognizes characters (hiragana, katakana, alphabet, kanji, numbers, or symbols, for example) and converts the characters into a character code.

The storage 40 includes one or more of read-only memory (ROM), random-access memory (RAM), and a solid-state drive (SSD). The storage 40 may include external memory. The external memory is removable media. The storage 40 includes for example Universal Serial Bus (USB) memory and a Secure Digital (SD) card as the external memory. The storage 40 stores various data and the control program for controlling operation of each section of the image processing device 100. The control program is executed by the processor of the controller 30.

The communication section 50 is capable of communication with an electronic device equipped with a communication device which uses the same communication method (protocol) as the communication section 50. According to the present embodiment, the communication section 50 communicates with an external information processing device (referred to as an “external device” in the following) through a network such as a local area network (LAN). The communication section 50 may also receive image data indicating the editing target image from the external device through the network. The communication section 50 is a communication module (communication device) such as a LAN board, for example.

The operation panel 120 receives various instructions from a user operating the image processing device 100. The operation panel 120 includes a display section 122. The display section 122 displays various information to be presented to the user. For example, the display section 122 displays an area pattern setting screen. Conditions for determining an area pattern from among a plurality of area patterns are received from the user in the area pattern setting screen. The display section 122 also displays an editing area determination screen. The editing area determination screen is a screen through which the user confirms whether or not to determine the editing area determined based on the determined area pattern. The operation panel 120 is an example of a presenting section and a receiving section.

The paper feed cassette 130 houses the recording medium P to be used for printing. When printing is performed, the recording medium P in the paper feed cassette 130 is conveyed by the paper conveyance section 140 so as to pass through the image forming section 20 and be ejected by the paper ejecting section 170.

The image processing device 100 performs image processing on the editable area of the editing target image. The “editing area” is an area including characters or character strings included in the editing target image on which image processing is to be performed. The editing target image has at least one marking image and a character string image including at least one character image. The editing target image is for example an image obtained by the image reading section 10 reading an image from the document M. The user marks characters in the document M. The user marks the characters or the character strings in the document M using a writing implement (a yellow or pink highlighter pen, for example). In the following, the characters or the character strings are referred to as “characters or the like”. The characters or the like may include symbols.

The editing target image may be an image received from the external device through the communication section 50. The editing target image may alternatively be an image including characters on data that the user has marked using software. According to the present embodiment, the image processing device 100 performs image processing on the characters or the like in the editing area determined in the editing target image.

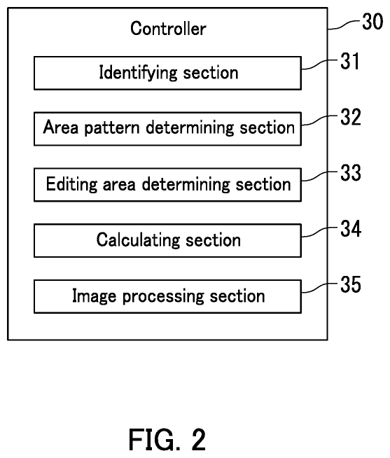

The following describes an editing area determination process through which the controller 30 determines the editing area with reference to FIGS. 1 and 2. FIG. 2 is a block diagram illustrating an example of the controller 30.

As illustrated in FIG. 2, the controller 30 includes an identifying section 31, an area pattern determining section 32, an editing area determining section 33, a calculating section 34, and an image processing section 35.

The identifying section 31 identifies marking included in a marking image. For example, the marking included in the marking image may exhibit one of the following: multiple types of brackets, multiple colors, multiple line widths, and multiple manners of a starting end. In such a case, the identifying section 31 identifies a type of brackets of the marking, a color of the marking, a line width of the marking, and a manner of the starting end of the marking included in the marking image.

The area pattern determining section 32 determines an area pattern from among the area patterns. Specifically, the area pattern determining section 32 determines an area pattern from among the area patterns based on at least one of the type of brackets of the marking, the color of the marking, the line width of the marking, and the manner of the starting end of the marking identified by the identifying section 31.

In a situation in which an area pattern is determined on marking through an initial setting, the area pattern may be switched from the area pattern determined through the initial setting to an area pattern specified by the user in the area pattern setting screen or the like. The area pattern determining section 32 is an example of a first determining section.

The editing area determining section 33 determines an area of at least some of a character string image to be the editing area based on the marking image included in the editing target image and the area pattern determined by the area pattern determining section 32. Image processing is performed on the characters or the like in the editing area.

The editing area determining section 33 may determine a removal area based on the marking image and the determined area pattern. The editing area determining section 33 may then determine an area in which the removal area has been removed from the area of the character string image to be the editing area. The editing area determining section 33 is an example of a second determining section.

The calculating section 34 calculates a degree of coverage. Herein, the “degree of coverage” is a degree to which the marking image covers a character image. For example, the degree of coverage is “1” when the marking image completely covers a character image of one character. The degree of coverage is “0.5” when the marking image covers half of a character image. The degree of coverage is “0.25” when a marking image covers one of four characters in a character image of four characters. The degree of coverage is “m/n” when a marking image covers m of n characters in a character image of n characters. When the marking image covers a character string image of multiple character strings, the degree of coverage is calculated in the same manner.

The image processing section 35 performs image processing on the characters or the like in the editing area. The image processing is for example character deletion, adding an underline, adding a box, and displaying colors as inverted.

The editing area determining section 33 may increase or decrease the editing area according to the degree of coverage calculated by the calculating section 34. When multiple character strings are marked for example, the degree to which the marking image covers each character string image is calculated. When the degree of coverage exceeds a predefined threshold, the editing area may be increased so as to include the character string image. When the degree to which the marking image covers the one character string image does not exceed the predefined threshold, the editing area may be decreased so as not to include the character string image.

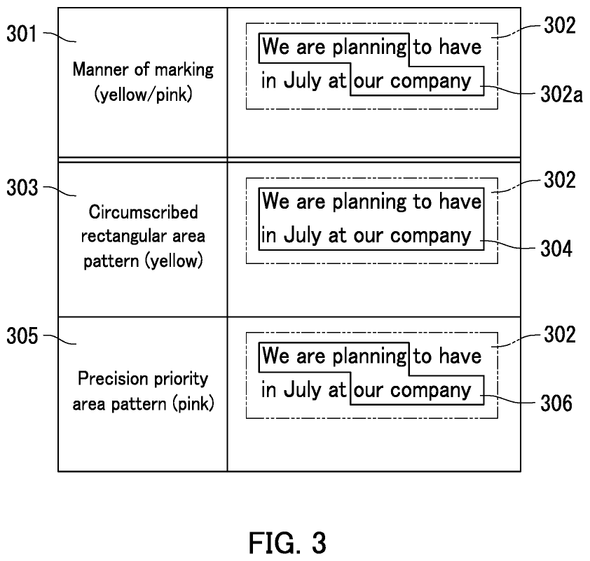

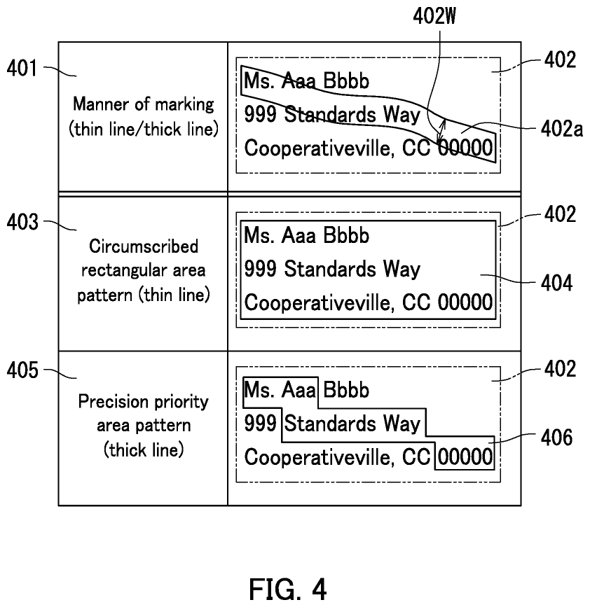

The area patterns may include a circumscribed rectangular area pattern defined by a rectangle circumscribing the entire marking image and a precision priority area pattern defined by the marking image. The circumscribed rectangular area pattern and the precision priority area pattern are described later with reference to FIGS. 3 and 4.

The following describes contents of processing performed by the area pattern determining section 32 with reference to FIGS. 3 to 5.

FIG. 3 schematically illustrates a first example of a correspondence relationship between a manner of marking and the area patterns.

FIG. 3 illustrates a manner of marking 301, a character string 302, marking 302a, a circumscribed rectangular area pattern 303, an editing area 304 corresponding to the circumscribed rectangular area pattern 303, a precision priority area pattern 305, and an editing area 306 corresponding to the precision priority area pattern 305. The marking 302a is colored in yellow or pink, for example. When yellow marking 302a is applied to the character string 302 in a Z shape, the circumscribed rectangular area pattern 303 is determined. When pink marking 302a is applied to the character string 302, the precision priority area pattern 305 is determined.

FIG. 4 schematically illustrates a second example of the correspondence relationship between the manner of marking and a plurality of area patterns.

FIG. 4 illustrates a manner of marking 401, a character string 402, marking 402a, a circumscribed rectangular area pattern 403, an editing area 404 corresponding to the circumscribed rectangular area pattern 403, a precision priority area pattern 405, and an editing area 406 corresponding to the precision priority area pattern 405. The marking 402a is applied as a thin line or a thick line, for example. When the marking 402a is applied to the character string 402 as the thin line in an oblique direction toward a lower left corner, the circumscribed rectangular area pattern 403 is determined. When the marking 402a is applied to the character string 402 as the thick line in an oblique direction toward the lower left corner, the precision priority area pattern 405 is determined. A “thin line” may be determined when a line width 402 W is less than a predefined threshold, and a “thick line” may be determined when the line width 402 W is at least the threshold.

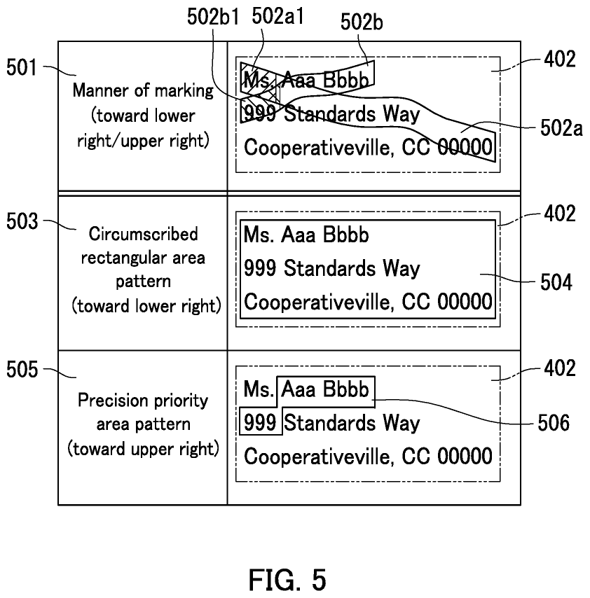

FIG. 5 schematically illustrates a third example of the correspondence relationship between the manner of marking and a plurality of area patterns.

FIG. 5 illustrates a manner of marking 501, the character string 402, marking 502a, marking 502b, a circumscribed rectangular area pattern 503, an editing area 504 corresponding to the circumscribed rectangular area pattern 503, a precision priority area pattern 505, and an editing area 506 corresponding to the precision priority area pattern 505. The marking 502a is marking in an oblique direction toward a lower right corner. The marking 502b is marking in an oblique direction toward an upper right corner. In a situation in which the marking 502a is applied to the character string 402, the circumscribed rectangular area pattern 503 is determined. In a situation in which the marking 502b is applied to the character string 402, the precision priority area pattern 505 is determined.

As further illustrated in FIG. 5, the area pattern determining section 32 may be configured to focus on a starting end 502al of the marking image 502a and a starting end 502b1 of the marking image 502b to determine the circumscribed rectangular area pattern 503 or the precision priority area pattern 505. For example, in a situation in which the starting end 502al of the marking image 502a indicates an oblique direction toward the lower right corner, the circumscribed rectangular area pattern 503 is determined. In a situation in which the starting end 502b1 of the marking image 502b indicates an oblique direction toward the upper right corner, the precision priority area pattern 505 is determined.

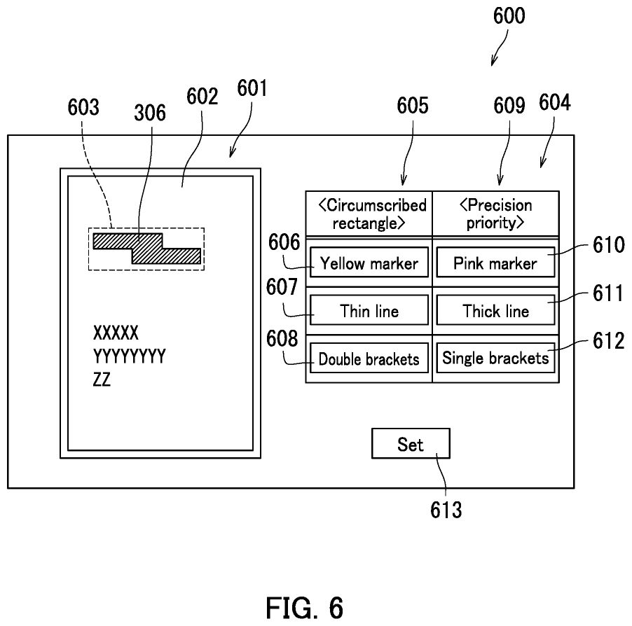

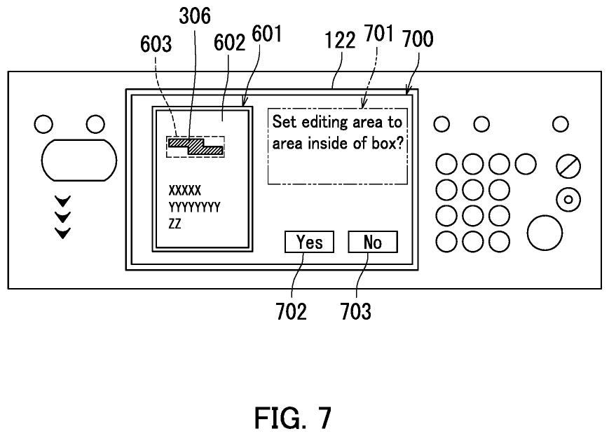

The following describes a method through which the area pattern is set and a method through which the editing area is determined according to the present embodiment with reference to FIGS. 6 and 7. FIG. 6 is a diagram illustrating an example of the area pattern setting screen according to the present embodiment.

FIG. 6 illustrates an area pattern setting screen 600. The area pattern setting screen 600 has a preview screen 601, a detailed setting screen 604, and a setting button 613. An editing target image 602 is displayed in the preview screen 601. An editing area (editing area 306, for example) corresponding to the area pattern determined based on the marking applied to the document M is exhibited in the editing target image 602.

The detailed setting screen 604 has a circumscribed rectangle setting field 605, and a precision priority setting field 609. In the circumscribed rectangle setting field 605, a condition for selecting the circumscribed rectangular area pattern is set. The circumscribed rectangle setting field 605 includes yellow marker 606, thin line 607, and double brackets 608. In the precision priority setting field 609, a condition for selecting the precision priority area pattern is set. The precision priority setting field 609 includes pink marker 610, thick line 611, and single brackets 612. Yellow marker 606, pink marker 610, thin line 607, thick line 611, double brackets 608, and single brackets 612 are set by a pull-down menu, for example.

Herein, “yellow marker” indicates that yellow marking applied to the document M is to be identified. “Pink marker” indicates that pink marking applied to the document M is to be identified. “Double brackets” indicates that marking applied to the document M including for example “[[” and “]]” is to be identified. “Single brackets” indicates that marking applied to the document M including for example “[” and “]” is to be identified.

When the user presses the setting button 613, the area pattern is determined by the content set in the circumscribed rectangle setting field 605 and the precision priority setting field 609.

FIG. 7 is a diagram illustrating an example of the editing area determination screen for determining the editing area according to the present embodiment. As illustrated in FIG. 7, an editing area determination screen 700 is displayed on the display section 122. The editing area determination screen 700 exhibits a preview screen 601, a confirmation message 701, a Yes button 702, and a No button 703. The preview screen 601 is the same as the preview screen 601 in FIG. 6.

The confirmation message 701 is a message for confirming whether or not to perform image processing on an editing area 603 exhibited in the preview screen 601. When the No button 703 is pressed in the editing area determination screen 700, setting of the condition for determining the area pattern in the area pattern setting screen 600 of FIG. 6 is corrected, or the editing target image is reread.

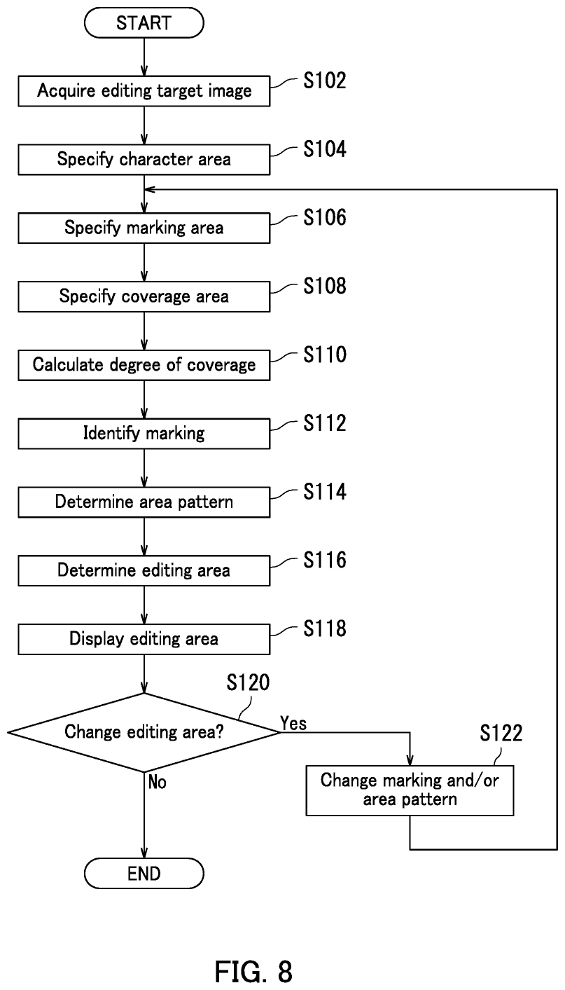

The following describes the editing area determination process according to the present embodiment with reference to FIGS. 1 to 8. FIG. 8 is a flowchart depicting the editing area determination process according to the present embodiment. The editing area of the editing target image 602 is determined by performing the process of Steps S102 to S124 depicted in FIG. 8.

Step S102: The controller 30 acquires an editing target image. The editing target image is for example an image obtained by the image reading section 10 reading an image from the document M. Alternatively, the editing target image may be an image received from the external device through the communication section 50. The process advances to Step S104.

Step S104: The controller 30 specifies a character area. The process advances to Step S106.

Step S106: The controller 30 specifies a marking area. The process advances to Step S108.

Step S108: The controller 30 specifies a coverage area. The process advances to Step S110.

Step S110: The calculating section 34 calculates a degree of coverage. The process advances to Step S112.

Step S112: The identifying section 31 identifies marking. The process advances to Step S114.

Step S114: The area pattern determining section 32 determines an area pattern. The process advances to Step S116.

Step S116: The editing area determining section 33 determines an editing area. The process advances to Step S118.

Step S118: The display section 122 displays the editing area. The process advances to Step S120.

Step S120: The editing area determining section 33 receives instruction from the user as for whether or not to change the displayed editing area. When the controller 30 determines that the displayed editing area is not to be changed based on the instruction (No in Step S120), the controller 30 finishes the editing area determination process. When the controller 30 determines that the displayed editing area is to be changed based on the instruction by contrast (Yes in Step S120), the process advances to Step S122.

Step S122: The controller 30 receives either or both acquisition of an editing target image on which the user has changed the marking and an area pattern changed by the user, and the process returns to S106.

According to the image processing device 100 of the present embodiment as described above, an editing area desired by the user can be easily determined on an image (editing target image) generated by reading a marked document M.

### Second Embodiment

The following describes an editing area determination process according to a second embodiment with reference to FIGS. 1 to 5, 9, and 10. According to the first embodiment, the editing area is determined based on the marking applied to the document M. The editing area determination process according to the second embodiment differs from the editing area determination process of the first embodiment in that marking received from the user is applied to a preview image displayed in the preview screen and the editing area is determined based on the marking.

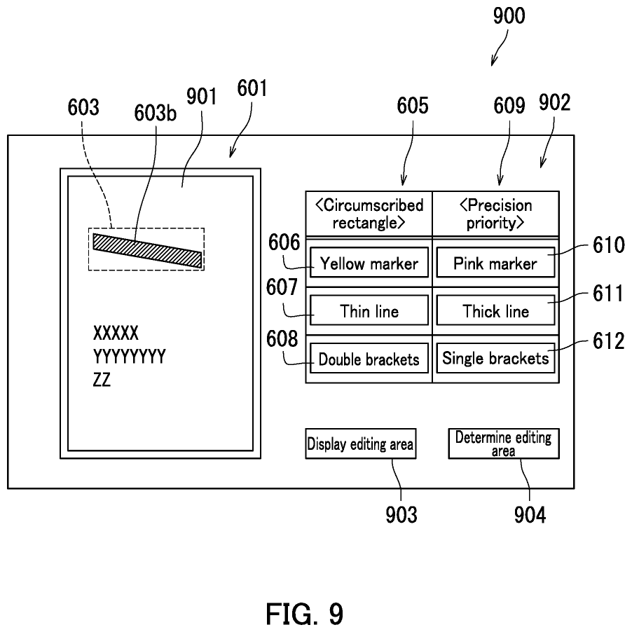

FIG. 9 is a diagram illustrating an example of the editing area determination screen according to the present embodiment. An editing area determination screen 900 has a preview screen 601 and a detailed determination screen 902. A preview image 901 is displayed in the preview screen 601. An image (an image 603b, for example) of marking selected by user operation is displayed in the preview image 901.

The detailed determination screen 902 has a circumscribed rectangle setting field 605, a precision priority setting field 609, an editing area display button 903, and an editing area determination button 904. The circumscribed rectangle setting field 605 and the precision priority setting field 609 are respectively the same as the circumscribed rectangle setting field 605 and the precision priority setting field 609 in FIG. 6. The editing area display button 903 is a button to be pressed by the user to display the editing area. The editing area determination button 904 is a button to be pressed by the user to determine the editing area.

Upon the user selecting any button in the detailed determination screen 902 for example, highlighting display is activated and it becomes possible to mark the preview image 901 with highlighting display content. For example, when the user selects thick line 611 in the detailed determination screen 902, the user can mark the preview image 901 with a thick line.

When the user presses the editing area display button 903 in the detailed determination screen 902, the editing area (an area 406, for example) is displayed over the preview image 901. The editing area is determined based on the area pattern and a marking image of the marking performed by the user.

When the user presses the editing area determination button 904 in the detailed determination screen 902, the editing area (area 406, for example) is determined.

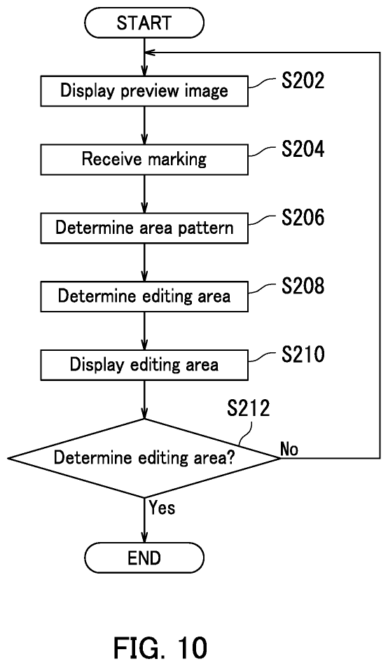

FIG. 10 is a flowchart depicting the editing area determination process according to the present embodiment. The editing area of the preview image 901 is determined by performing a process of Steps S202 to S212 depicted in FIG. 10.

Step S202: The controller 30 causes the display section 122 to display the preview image 901. The preview image 901 is for example an image or the like received from the external device through the communication section 50, and is equivalent to the editing target image of the first embodiment. The process advances to Step S204.

Step S204: The controller 30 receives marking on the preview image 901 from the user through the operation panel 120. The process advances to Step S206.

Step S206: The area pattern determining section 32 determines an area pattern based on the marking image of the marking received from the user. The process advances to Step S208.

Step S208: The editing area determining section 33 determines an editing area based on the marking image and the area pattern. The process advances to Step S210.

Step S210: The controller 30 displays the determined editing area on the display section 122. The process advances to Step S212.

Step S212: The editing area determining section 33 receives an instruction from the user as for whether or not to determine the displayed editing area. When the editing area determining section 33 determines that no instruction to determine the editing area has been received (No in Step S212), the process returns to Step S202. When the editing area determining section 33 determines that an instruction to determine the editing area has been received (Yes in Step S212), the process ends.

According to the image processing device 100 of the present embodiment as described above, an editing area desired by the user in the image (preview image) displayed in the preview screen can be easily determined.

The embodiments of the present disclosure are described so far with reference to the accompanying drawings (FIGS. 1 to 10). However, the present disclosure is not limited to the above embodiments and may be implemented in various manners within a scope not departing from the gist thereof (as indicated below in (1) and (2), for example). The drawings illustrate main elements of configuration schematically to facilitate understanding thereof. Aspects of the elements of configuration in the drawings, such as thickness, length, and number thereof, may differ in practice for the sake of convenience for drawing preparation. Furthermore, aspects of the elements of configuration described in the above embodiments such as material, shape, and dimension thereof are merely examples and not particular limitations. The elements of configuration may be variously altered within a scope not substantially departing from the effects of the present disclosure.

(1) The embodiments of the present disclosure describe a multifunction peripheral as an example of the image processing device 100, but the image processing device 100 is not limited to a multifunction peripheral. For example, the image processing device 100 may be any scanner or printer which includes an operation panel 120.

(2) Furthermore, a smartphone or a tablet terminal may be an example of the image processing device 100 described in the embodiments of the present disclosure.

Also, the present disclosure may be implemented as an image processing method including, as steps, the characteristic means of configuration of the image processing device according to the present disclosure, or may be implemented as a control program including those steps. The program may be distributed through a permanent storage medium such as a CD-ROM or a communication medium such as a communication network.

What is claimed is:

1. An image processing device for performing image processing on image data, the image data indicating an editing target image including a character string image including at least one character image and at least one marking image, the image processing device comprising:
a first determining section configured to determine an area pattern from among a plurality of area patterns; and
a second determining section configured to determine, as an editing area on which the image processing is to be performed, an area of at least a portion of the character string image based on the marking image and the determined area pattern.

2. The image processing device according to claim 1, further comprising:
a presenting section configured to present the plurality of area patterns; and
a receiving section configured to receive selection of the area pattern from among the plurality of area patterns, wherein
the first determining section determines the area pattern from among the plurality of area patterns based on the selected area pattern.

3. The image processing device according to claim 1, further comprising
an identifying section configured to identify marking included in the marking image, wherein
the first determining section determines the area pattern from among the plurality of area patterns based on the identified marking.

4. The image processing device according to claim 3, wherein
the marking included in the marking image exhibits one of multiple types of brackets,
the identifying section identifies a type of brackets exhibited by the marking, and
the first determining section determines the area pattern from among the plurality of area patterns based on the identified type of brackets.

5. The image processing device according to claim 3, wherein
the marking included in the marking image exhibits one of multiple colors,
the identifying section identifies a color exhibited by the marking, and
the first determining section determines the area pattern from among the plurality of area patterns based on the identified color.

6. The image processing device according to claim 3, wherein
the marking included in the marking image exhibits one of multiple line widths,
the identifying section identifies a line width exhibited by the marking, and
the first determining section determines the area pattern from among the plurality of area patterns based on the identified line width.

7. The image processing device according to claim 3, wherein
the marking included in the marking image exhibits one of multiple manners of a starting end,
the identifying section identifies a manner of the starting end exhibited by the marking, and
the first determining section determines the area pattern from among the plurality of area patterns based on the identified manner of the starting end.

8. The image processing device according to claim 1, wherein
the second determining section determines a removal area based on the marking image and the determined area pattern, and determines as the editing area an area in which the removal area has been removed from an area of the character string image.

9. The image processing device according to claim 1, further comprising
a calculating section configured to calculate a degree of coverage which is a degree to which the marking covers the character image, wherein
the second determining section increases or decreases the editing area according to the calculated degree of coverage.

10. The image processing device according to claim 1, wherein
the plurality of area patterns includes a circumscribed rectangular area pattern defined by a rectangle circumscribing the entire marking image and a precision priority area pattern defined by the marking image.

11. An image processing method by which image processing is performed on image data, the image data indicating an editing target image including a character string image including at least one character image and at least one marking image, the image processing method comprising:
determining an area pattern from among a plurality of area patterns; and
determining, as an editing area on which the image processing is to be performed, an area of at least a portion of the character string image based on the marking image and the determined area pattern.
